(19) United States
(12) Patent Application Publication
(10) Pub. No.: US 2025/0303279 A1
(43) Pub. Date: Oct. 2, 2025

(54) Game Control System and Game Control Method Based on Visual Recognition Algorithm

(71) Applicants: Hyundai Motor Company, Seoul (KR); Kia Corporation, Seoul (KR)

(72) Inventors: Jun Zhou, Yantai (CN); Yicheng Fan, Yantai (CN); Sungbo Yang, Hwaseong-si (KR); Yao Yao, Yantai (CN)

(21) Appl. No.: 19/079,697

(22) Filed: Mar. 14, 2025

(30) Foreign Application Priority Data
Mar. 26, 2024 (CN) 202410353372.6

(51) Int. Cl. A63F 13/40; G06V 40/10

(52) U.S. Cl. CPC A63F 13/40; G06V 40/103

(57) ABSTRACT

A system and method provides an interactive in-vehicle gaming experience in which a game console detected in a vehicle communicates with the vehicle to use one or more vehicle parts to detect motions of one or more passengers to provide a wireless vehicle user interface for the game console.

### CROSS-REFERENCE TO RELATED APPLICATION

This application claims priority to and the benefit of Chinese Patent Application No. 202410353372.6 filed in the Chinese National Intellectual Property Administration on Mar. 26, 2024, the entire contents of which are incorporated herein by reference.

### BACKGROUND OF THE INVENTION

### (a) Field of the Invention

The present disclosure relates to a game control system and a game control method based on a visual recognition algorithm that allows a user to control a game through body posture inside a vehicle.

### (b) Description of the Related Art

If a user is playing an electronic game inside a vehicle, the user may need to use buttons or a touch screen to interact with the game. Further, when the user wishes to play an electronic game of a game console while lying in a chair, the user may need to use an external device, such as a game pad, to interact with the game. That said, for a game such as racing, interacting with the game via buttons, a touch screen, or a game pad does not provide the user with a better immersive gaming experience.

Therefore, there is a need for research on a game control system and a game control method that enable users to obtain a better immersive gaming experience when playing electronic games inside a vehicle.

The matters described in the description of the related art are prepared to enhance the understanding of the background of the invention, and may include matters that are not already known to those skilled in the art to which the present technology belongs.

### SUMMARY

The present disclosure provides a game control system and a game control method based on a visual recognition algorithm that is capable of solving the above-mentioned problems.

The present disclosure provides a game control system based on a visual recognition algorithm, including one or more of: a camera provided in an interior of a vehicle to acquire an image including a human body; a first control unit configured to determine a left and right tilt posture value and a forward and backward tilt posture value corresponding to a posture of the human body in the image acquired by the camera, and to determine a leftward tilt or a rightward tilt, or a forward tilt or a backward tilt of the human body by comparing the determined left and right tilt posture value and the determined forward and backward tilt posture value with a left and right tilt posture threshold and a forward and backward tilt posture threshold; and a second control unit configured to control the game based on the result of the leftward tilt or the rightward tilt, or the forward tilt or the backward tilt of the human body determined by the first control unit.

The first control unit may be configured to acquire, prior to starting the game, an initial image including a human body through the camera, and determine whether the initial image includes one or more people. If the initial image includes one or more people, the first control unit may determine a game participant according to a predetermined rule, extract an image region of the game participant in the initial image, and/or determine the left and right tilt posture threshold and the forward and backward tilt posture threshold corresponding to the posture of the human body in the initial image.

The first control unit may be configured to determine an external parameter matrix between a camera coordinate system and a global coordinate system based on the initial image to which a human body detection algorithm is applied when determining the forward and backward tilt posture threshold corresponding to the human body posture in the initial image, and apply a monocular depth estimation algorithm to the initial image to determine a human body depth in the camera coordinate system, and convert, based on the determined external parameter matrix, the determined human body depth in the camera coordinate system to the human body depth in the global coordinate system, to determine the forward and backward tilt posture threshold corresponding to the posture of the human body in the initial image.

The first control unit may be configured to acquire, through the camera, a real-time image including the human body during execution of the game when determining the leftward tilt or the rightward tilt, or the forward tilt or the backward tilt of the human body, apply the human body detection algorithm to the real-time image to extract an image region of the game participant in the real-time image, apply a skeletal key point detection algorithm to the extracted image region of the game participant to determine the left and right tilt posture value corresponding to the posture of the human body in the real-time image, and compare the left and right tilt posture value determined from the real-time image with the left and right tilt posture threshold determined from the initial image. When the left and right tilt posture value is greater than the left and right tilt posture threshold, the first control unit may determine that the human body is tilted to the left, and when the left and right tilt posture value is less than or equal to the left and right tilt posture threshold, the first control unit may determine that the human body is tilted to the right.

The first control unit may be configured to, when determining the leftward tilt or the rightward tilt of the human body, or the forward tilt or the backward tilt of the human body, apply a monocular depth estimation algorithm to the extracted image region of the game participant to determine the forward and backward tilt posture value corresponding to the posture of the human body in the real-time image, and compare the forward and backward tilt posture value determined from the real-time image with the forward and backward tilt posture threshold determined from the initial image. When the forward and backward tilt posture value is greater than the forward and backward tilt posture threshold, the first control unit may determine that the human body is tilted forward, and when the forward and backward tilt posture value is less than or equal to the forward and backward tilt posture threshold, the first control unit may determine that the human body is tilted backward.

Also described herein is a game control method based on a visual recognition algorithm, including: acquiring, by a camera provided in an interior of a vehicle, an image including a human body; determining, by a first control unit, a left and right tilt posture value and a forward and backward tilt posture value corresponding to a posture of the human body in the image acquired by the camera; determining, by the first control unit, a leftward tilt or a rightward tilt, or a forward tilt or a backward tilt of the human body by comparing the determined left and right tilt posture value and the determined forward and backward tilt posture value with a left and right tilt posture threshold and a forward and backward tilt posture threshold, respectively; and controlling, by a second control unit, the game based on the result of the leftward tilt or the rightward tilt, or the forward tilt or the backward tilt of the human body determined by the first control unit.

The game control method may further include: acquiring, prior to starting the game, an initial image including the human body through the camera; and determining, by the first control unit, whether the initial image includes one or more people. The game control method may further include: when it is determined that the initial image includes one or more people, determining, by the first control unit, a game participant according to a predetermined rule; extracting an image region of the game participant in the initial image; and determining the left and right tilt posture threshold and the forward and backward tilt posture threshold corresponding to the posture of the human body in the initial image.

The determining the left and right tilt posture threshold and the forward and backward tilt posture threshold corresponding to the posture of the human body in the initial image may include: determining, by the first control unit, an external parameter matrix between a camera coordinate system and a global coordinate system based on the initial image to which a human body detection algorithm is applied; applying, by the first control unit, a monocular depth estimation algorithm to the initial image to determine a human body depth in the camera coordinate system; and converting, by the first control unit, based on the determined external parameter matrix, the determined human body depth in the camera coordinate system to the human body depth in the global coordinate system to determine the forward and backward tilt posture threshold corresponding to the posture of the human body in the initial image.

The determining a leftward tilt or a rightward tilt, or a forward tilt or a backward tilt of the human body may include: acquiring, through the camera, a real-time image including the human body during execution of the game; applying, by the first control unit, a human body detection algorithm to the real-time image to extract an image region of the game participant in the real-time image; applying a skeletal key point detection algorithm to the extracted image region of the game participant to determine the left and right tilt posture value corresponding to the posture of the human body in the real-time image; and comparing, by the first control unit, the left and right tilt posture value determined from the real-time image with the left and right tilt posture threshold determined from the initial image. When the left and right tilt posture value is greater than the left and right tilt posture threshold, the first control unit may determine that the human body is tilted to the left, and when the left and right tilt posture value is smaller than or equal to the left and right tilt posture threshold, the first control unit may determine that the human body is tilted to the right.

The determining a leftward tilt or a rightward tilt, or a forward tilt or a backward tilt of the human body may further include: applying, by the first control unit, a monocular depth estimation algorithm to the extracted image region of the game participant to determine the forward and backward tilt posture value corresponding to the posture of the human body in the real-time image; and comparing, by the first control unit, the forward and backward tilt posture value determined from the real-time image with the forward and backward tilt posture threshold determined from the initial image. When the forward and backward tilt posture value is greater than the forward and backward tilt posture threshold, the first control unit may determine that the human body is tilted forward; and when the forward and backward tilt posture value is less than or equal to the forward and backward tilt posture threshold, the first control unit may determine that the human body is tilted backward.

A method for providing a game may comprise: communicating, via a communication interface of a vehicle, with a game device detected in the vehicle; capturing, by one or more cameras of the vehicle, one or more first images depicting an interior of the vehicle; receiving, by an image processor of the vehicle, the one or more first images from the one or more cameras; processing, by the image processor, the one or more first images to identify one or more human bodies; identifying, from the one or more human bodies, a participant of a game executed on the game device; receiving, by the image processor from the one or more cameras, one or more second images depicting the participant of the game; processing the one or more second images to determine a degree of tilt, by the participant of the game, in one or more directions; transmitting, to the game device via the communication interface of the vehicle, a signal indicating the determined degree of tilt; and causing the game device to control of an interactive portion of the game based on comparing the degree of tilt to a threshold.

The processing the one or more second images to determine the degree of tilt may comprise processing the one or more second images using a monocular depth estimation algorithm.

The processing the one or more second images to determine the degree of tilt may comprise processing the one or more second images using a skeletal key point detection algorithm.

The threshold may be based on a location of the participant of the game in the one or more first images.

The processing the one or more first images may comprise using a human body detection algorithm to identify the one or more human bodies.

The processing the one or more second images to determine the degree of tilt may comprise: determining a camera coordinate system corresponding to the one or more cameras; determining a global coordinate system; and comparing the camera coordinate system and the global coordinate system.

The communicating, via the communication interface of the vehicle, with the game device may comprise: receiving, from the game device via the communication interface, a wireless signal indicating a request for detecting the participant of the game and for determining the degree of tilt.

The one or more cameras may be located on a front windshield glass of the vehicle.

The identifying the participant of the game may be based on determining that the participant is in a front seat of the vehicle.

It may be possible to capture a user's body posture in real time through a camera installed inside the vehicle, and control a game according to the captured user's body posture, thereby enabling the user to obtain the better immersive gaming experience without using buttons, touch screens, or game pads.

Other effects that may be obtained or anticipated herein are disclosed, directly or by implication, in the detailed description of the present disclosure. That is, various effects will be disclosed in the detailed description which is to be given below.

### BRIEF DESCRIPTION OF THE DRAWINGS

The foregoing and other objects, features, and advantages of the present disclosure will become apparent from the following detailed description, which is accompanied by the drawings.

FIG. 1 is a block diagram illustrating a game control system based on a visual recognition algorithm.

FIG. 2 is a flow diagram illustrating a game control method based on a visual recognition algorithm.

FIG. 3 is a flow diagram of a process of determining a forward and backward tilt in a game control method based on a visual recognition algorithm.

FIG. 4 is a flow diagram of a process of determining a left and right tilt in a game control method based on a visual recognition algorithm.

FIG. 5 is an example block diagram illustrating a computing system associated with a vehicle for executing the game control methods in the vehicle.

It should be understood that the drawings simply illustrate features in order to explain the basic principles of the present disclosure, and are not necessarily drawn to scale. In the drawings of the present disclosure, identical reference numerals indicate identical or equivalent components of the present disclosure.

### DETAILED DESCRIPTION

Hereinafter, the present disclosure will be referred to in detail and will be described later by exemplifying these concepts in the drawings. While the present disclosure has been described in conjunction with various embodiment(s), it is to be understood that the present specification is not intended to limit the invention to those embodiment(s). To the contrary, the present disclosure not only includes these embodiments, but also includes various alternatives, modifications, equivalents, and other implementations within the spirit of the invention and the scope defined by the appended claims.

A game control system and a game control method based on a visual recognition algorithm may capture a user's body posture in real time through a camera installed inside a vehicle, and control a game according to the captured user's body posture, thereby enabling the user to obtain a better immersive gaming experience without using buttons, touch screens, or game pads.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” may be used interchangeably with “at least one of”.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are necessary for controlling a function assigned thereto.

Also, or additionally, throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Hereinafter, various details of the present disclosure will be described in more detail with reference to the drawings.

In one or more aspects of the present disclosure, a system and method provides an interactive in-vehicle gaming experience in which a game console detected in a vehicle communicates with the vehicle to use one or more vehicle parts to detect motions of one or more passengers to provide a wireless vehicle user interface for the game console.

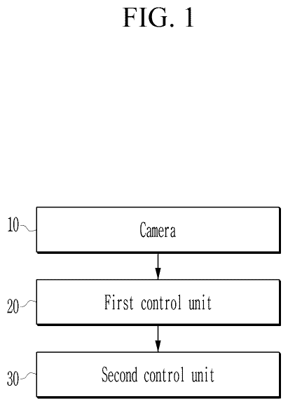

FIG. 1 is a block diagram illustrating a game control system based on a visual recognition algorithm.

As shown in FIG. 1, the game control system may include a camera 10, a first control unit 20 (e.g., a controller including at least one processor and memory, such as an image processor of a vehicle communicating with one or more cameras of the vehicle), and a second control unit 30 (e.g., a controller including at least one processor and memory, such as a game device, a game console, etc. detected in the vehicle).

The first control unit 20 may communicate with the second control unit 30 via a wireless communication (e.g., via a short-range wireless communication, such as Bluetooth, BLE, Wi-Fi, etc.) and/or a wired communication (e.g., if the second control unit 30 is connected to a communication interface of the vehicle).

The vehicle and the second control unit 30 may include one or more display screens to display the game play of the game executed by the second control unit 30. If more than one passengers are playing the game (e.g., a multi-player game), a plurality of cameras of the vehicle may detect respective motions of each passenger detected as game participants. One or more speakers of the vehicle may output audible sounds of the game and/or one or more earphones may be communicatively coupled to the second control unit 30 to output audible sounds of the game. For example, one or more speakers located around each game participating passenger or one or more earphones of each game participating passenger may output audible sound that is associated with the respective game participant.

The camera 10 may be installed inside a vehicle to acquire images including a human body. The camera 10 may be installed on a front windshield glass of the vehicle to capture images of a user seated on a front seat (and/or a rear seat). The camera 10 may be activated in response to execution of a game. Prior to starting the game, the camera 10 may select one frame from the captured images of the user as an initial image, which may be used to determine an initial human body posture of the user. During playing the game, the camera 10 may capture the images of the user in real time, and apply a visual recognition algorithm to each frame of the real-time captured image of the user to determine the real-time human body posture of the user. The game control system may control the game according to the determined real-time human body posture.

The first control unit 20 is provided for determining the human body posture. The first control unit 20 may be a processor that executes the visual recognition algorithm to apply the visual recognition algorithm to the image acquired by the camera 10. The visual recognition algorithm may include a human body detection algorithm, a skeletal key point detection algorithm, and a monocular depth estimation algorithm.

The human body detection algorithm may extract the human body from the image captured by the camera 10. If the image captured by the camera includes a plurality of users, the human body detection algorithm may score each of the plurality of users. The score may be related to an image quality, such that, as the image quality is higher, the score is higher. The human body detection algorithm may determine that the user with the highest score among the plurality of users is a game participant, and may extract the image of the game participant for further image processing.

Skeletal key point detection (pose estimation) refers to detecting some feature points of the human body, such as joints and faces, and describing human skeletal information through the detected feature points. The skeletal key point detection algorithm may detect a head and a trunk of the human body included in the image captured by the camera 10 as the feature points, and extracts features of the feature points that may express motion information of the human body leaning to the left or leaning to the right, so that a left and a right leaning posture of the human body may be determined. If the position of the feature point deviates from the center position by a predetermined value or more, the skeletal key point detection algorithm may determine that the human body is tilted to the left or the right.

Monocular depth estimation refers to an estimation of a distance of each pixel in the image from a photography source through an RGB image at a single viewing angle. The monocular depth estimation algorithm may determine a distance of the human body to the camera from the human body included in the image captured by the camera 10, thereby determining a forward and a backward tilt posture of the human body. When the distance of the human body to the camera 10 deviates from an initial distance by a predetermined value or more, the monocular depth estimation algorithm may determine that the human body is tilted forward or backward.

Since there may be multiple occupants in the vehicle, the game control system may first determine a person to participate in the game (hereinafter referred to as the “game participant”) among the multiple occupants before the game starts, and may then control the game according to the human body posture of the determined game participant.

For example, prior to the start of the game, the first control unit 20 may photograph the image including the occupant inside the vehicle via the camera 10 to use the photographed image as an initial image. The first control unit 20 may apply the human body detection algorithm to the initial image to determine whether the initial image includes one or more people.

If it is determined that the initial image includes one or more people, the first control unit 20 may determine that the person with the highest score (typically the person closest to the camera 10) after applying the human body detection algorithm is the game participant. Additionally, the first control unit 20 may extract an image region of the game participant from the initial image. While the present disclosure has been described using one game participant as an example, the present disclosure is not limited thereto and one or more game participants may be selected.

When the game participant is determined, the initial human body posture of the game participant may be determined, and the human body posture of the game participant during the game execution may be compared with the initial human body posture to determine whether the game participant has a leftward tilt, a rightward tilt, a forward tilt, or a backward tilt.

For example, the first control unit 20 may apply the skeletal key point detection algorithm and the monocular depth estimation algorithm to the extracted image region of the game participant to determine a left and right tilt posture threshold and a forward and backward tilt posture threshold corresponding to the human body of the game participant posture in the initial image.

On one hand, when the first control unit 20 determines the forward and backward tilt posture threshold corresponding to the human body posture in the initial image, the first control unit 20 may determine an external parameter matrix between the camera coordinate system of the camera 10 and a global coordinate system according to the initial image to which the human body detection algorithm is applied. The external parameter matrix is a matrix for converting coordinates in the camera coordinate system of the object to coordinates in the global coordinate system. Once the external parameter matrix of the camera 10 is determined, the distance of the camera 10 from the game participant in the real environment (hereinafter referred to as a “human body depth”) may be determined from a two-dimensional image photographed by the camera 10.

For instance, the first control unit 20 may apply the monocular depth estimation algorithm to the initial image to which the human body detection algorithm is applied to determine the human body depth in the camera coordinate system. According to the determined external parameter matrix, the first control unit 20 may convert the determined human body depth in the camera coordinate system to a human body depth in the global coordinate system, and determine the human body depth in the global coordinate system as the forward and backward tilt posture threshold corresponding to the human body posture of the game participant in the initial image.

On the other hand, when the left and right tilt posture threshold corresponding to the human body posture of the initial image, the first control unit 20 may apply the skeletal key point detection algorithm to the initial image to which the human body detection algorithm is applied to determine the left and right tilt posture threshold corresponding to the human body posture of the game participant in the initial image.

Once the left and right tilt posture threshold and the forward and backward posture threshold are determined, the first control unit 20 may transmit a signal to the second control unit 30, whereby the second control unit 30 may begin executing the game. The second control unit 30 may be a control unit of the game.

During playing the game, the first control unit 20 may acquire the real-time images photographed by the camera 10. The first control unit 20 may apply the human body detection algorithm to the real-time image to extract the image region of the game participant in the real-time image.

The first control unit 20 may apply the skeletal key point detection algorithm to the extracted image region of the game participant to determine a left and right tilt posture value corresponding to the human body posture of the game participant in the real-time image. The first control unit 20 may compare the left and right tilt posture value determined from the real-time image to the left and right tilt posture threshold determined from the initial image.

If the left and right tilt posture value is greater than the left and right tilt posture threshold, the first control unit 20 may determine that the human body of the game participant is tilted to the left, and when the left and right tilt posture value is less than or equal to the left and right tilt posture threshold, the first control unit 20 may determine that the human body of the game participant is tilted to the right.

In an example, the first control unit 20 may (e.g., simultaneously) apply the monocular depth estimation algorithm to the extracted image region of the game participant to determine a forward and backward tilt posture value corresponding to the human body posture of the game participant in the real-time image. The first control unit 20 may compare the forward and backward tilt posture value determined from the real-time image to the forward and backward tilt posture threshold determined from the initial image.

If the forward and backward tilt posture value is greater than the forward and backward posture threshold, the first control unit 20 may determine that the human body of the game participant is tilted forward, and if the forward and backward tilt posture value is less than or equal to the forward and backward tilt posture threshold, the first control unit 20 may determine that the human body of the game participant is tilted backward.

The first control unit 20 may transmit the result of the determined leftward tilt, rightward tilt, forward tilt, or backward tilt of the human body of the game participant to the second control unit 30. Thus, the second control unit 30 may control the execution of the game according to the result of the determination of the first control unit 20.

The first control unit 20 and the second control unit 30 may be separately installed control units, or may be formed of one or more control units installed in the vehicle.

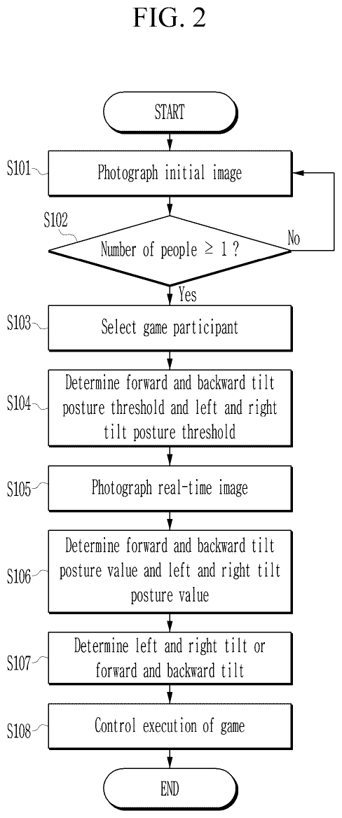

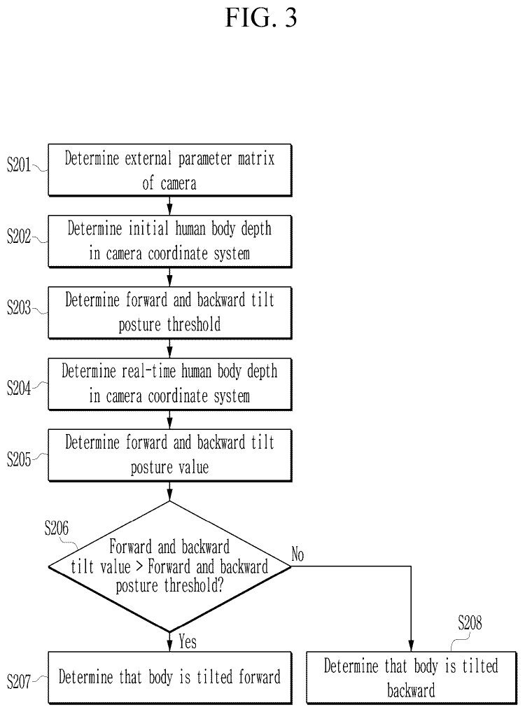

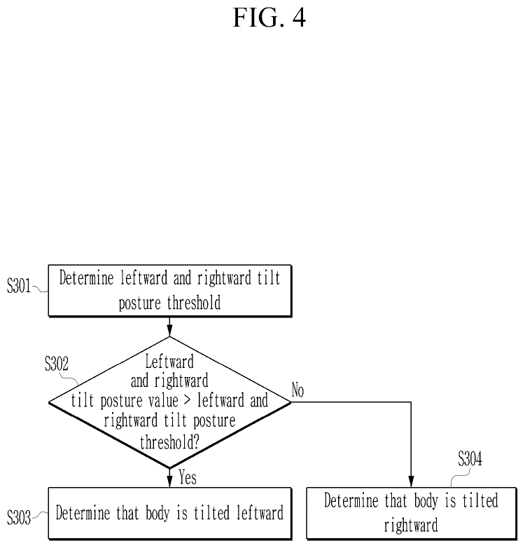

FIGS. 2 to 4 are flow diagrams illustrating a game control method based on a visual recognition algorithm, and in particular, FIG. 3 is a flow diagram of a process for determining a forward and backward tilt of a human body of a game participant, and FIG. 4 is a flow diagram of a process for determining a left and right tilt of a human body of a game participant.

As shown in FIG. 2, in operation S101, the camera 10 may photograph the image including the occupant inside the vehicle and use the photographed image as the initial image.

In operation S102, the first control unit 20 may apply the human body detection algorithm to the initial image photographed by the camera 10 to determine whether the number of people included in the initial image is one or more.

If it is determined that the number of people included in the initial image is one or more (“Yes” in the operation S102), the first control unit 20 may select one person as the game participant in operation S103. The first control unit 20 may determine that the person with the highest score (typically the person closest to the camera 10) after applying the human body detection algorithm is the game participant.

In operation S104, the first control unit 20 may apply the monocular depth estimation algorithm and the skeletal key point detection algorithm to the extracted image region of the game participant to determine the left and right tilt posture threshold and the forward and backward tilt posture threshold corresponding to the human body of the game participant posture in the initial image.

If it is determined that the initial image does not include a person (“No” in the operation S102), the system may return to the operation S101 and photograph the initial image again.

In response to the determination of the forward and backward tilt posture threshold and the left and right tilt posture threshold, the second control unit 30 may begin executing the game. During the game execution, in operation S105, the camera 10 may photograph the real-time image.

In operation S106, the first control unit 20 may apply the human body detection algorithm to the real-time image to extract the image region of the game participant in the real-time image. The first control unit 20 may apply the monocular depth estimation algorithm and the skeletal key point detection algorithm to the extracted image region of the game participant, to determine the forward and backward tilt posture value and the left and right tilt posture value corresponding to the human body posture of the game participant in the real-time image.

In operation S107, the first control unit 20 may compare the forward and backward tilt posture value and the left and right tilt posture value determined through the real-time image with the forward and backward tilt posture threshold and the left and right tilt posture threshold determined via the initial image to determine whether the human body of the game participant has tilted to leftward or rightward, or forward or backward. The first control unit 20 may transmit the determination result to the second control unit 30.

In operation S108, the second control unit 30 may control the execution of the game according to the received determination result.

FIGS. 3 and 4 are flow diagrams of a process of determining a forward and backward tilt and a left and right tilt in a game control method based on a visual recognition algorithm.

As shown in FIG. 3, in operation S201, the first control unit 20 may determine the external parameter matrix between the camera coordinate system of the camera 10 and the global coordinate system according to the initial image to which the human body detection algorithm is applied.

In operation S202, the first control unit 20 may apply the monocular depth estimation algorithm to the image region of the game participant extracted from the initial image to determine the initial human body depth in the camera coordinate system.

In operation S203, the first control unit 20 may apply the determined external parameter matrix to the determined initial human body depth in the camera coordinate system to convert the initial human body depth in the camera coordinate system to the initial human body depth in the global coordinate system, and determine the initial human body depth in the global coordinate system as the forward and backward tilt posture threshold corresponding to the human body posture of the game participant in the initial image.

In operation S204, the first control unit 20 may apply the monocular depth estimation algorithm to the extracted image region of the game participant in the real-time image to determine the real-time human body depth in the camera coordinate system.

In operation S205, the first control unit 20 may apply the external parameter matrix to the determined real-time human body depth in the camera coordinate system to convert the real-time human body depth in the camera coordinate system to the real-time human body depth in the global coordinate system, and determine the real-time human body depth in the global coordinate system as the forward and backward tilt posture value corresponding to the human body posture of the game participant in the real-time image.

In operation S206, the first control unit 20 may determine whether the forward and backward tilt posture value determined through the real-time image is greater than the forward and backward tilt posture threshold determined through the initial image.

If the forward and backward tilt posture value is greater than the forward and backward tilt posture threshold (“Yes” in the operation S206), the first control unit 20 may determine that the body of the game participant is tilted forward, and transmit the determination result to the second control unit 30 in operation S207.

If the forward and backward tilt posture value is less than or equal to the forward and backward tilt posture threshold (“No” in the operation S206), the first control unit 20 may determine that the human body of the game participant is tilted backward and transmit the determination result to the second control unit 30 in operation S208.

As shown in FIG. 4, in operation S301, the first control unit 20 may apply the skeletal key point detection algorithm to the image region of the game participant extracted from the initial image to determine the left and right tilt posture threshold corresponding to the human body posture of the game participant in the initial image.

In operation S302, the first control unit 20 may determine whether the left and right tilt posture value determined through the real-time image is greater than the left and right tilt posture threshold.

If the left and right tilt posture value is greater than the left and right tilt posture threshold (“Yes” in the operation S302), the first control unit 20 may determine that the human body of the game participant is tilted to the left, and transmit the determination result to the second control unit 30 in operation S303.

If the left and right tilt posture value is less than or equal to the left and right tilt posture threshold (“No” in the operation S302), the first control unit 20 may determine that the human body of the game participant is tilted to the right and transmit the determination result to the second control unit 30 in operation S304.

The game control system and the game control method based on the visual recognition algorithm may enable the user to control the game through the body posture inside the vehicle, resulting in a better immersive gaming experience.

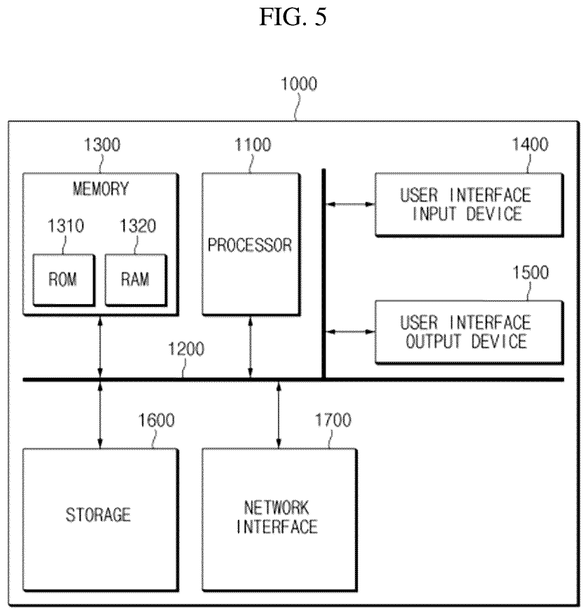

FIG. 5 is an example block diagram illustrating a computing system associated with a vehicle for executing the game control methods in the vehicle.

A computing system 1000 may include at least one processor 1100, a memory 1300, a user interface input device 1400, a user interface output device 1500, storage 1600, and/or a network interface 1700, which may be connected with each other through a system bus 1200. The computing system 1000 may be used to implement one or more devices, modules, components, and/or subcomponents as described in FIGS. 1-4.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the features disclosed in the specification may be directly implemented with a hardware module, a software module, or a combination of the hardware module and the software module, which is executed by the processor 1100. The software module may reside on a storage medium (e.g., the memory 1300 and/or the storage 1600) such as a random access memory (RAM), a flash memory, a read only memory (ROM), an erasable and programmable ROM (EPROM), an electrically EPROM (EEPROM), a register, a magnetic storage device (e.g., a hard disk drive), a solid-state memory device (e.g., a solid-state drive (SSD)), a removable disc, and/or a compact disc-ROM (CD-ROM). For example, the storage medium may be coupled to the processor 1100. The processor 1100 may read out information from the storage medium and may write information in the storage medium. Alternatively or additionally, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is for the purpose of explanation and description. The above description is not intended to be exhaustive or to limit the present disclosure to the precise form disclosed, and obviously, slight modifications and changes are possible in accordance with the teachings above. In order to interpret specific principles of the invention and its practical applications; an implementation may be selected and described, and through this, others skilled in the art may use and implement various implementations and various alternative methods and modifications of the present disclosure. The scope of the present disclosure is defined by the appended claims and their equivalents.

What is claimed is:

1. A game control system based on a visual recognition algorithm, comprising:
a camera provided in an interior of a vehicle to acquire an image including a human body;
a first processor configured to:
receive the image from the camera;
determine a left and right tilt posture value corresponding to a posture of the human body in the image acquired by the camera and a forward and backward tilt posture value corresponding to the posture of the human body in the image,
determine a leftward tilt of the human body or a rightward tilt of the human body, or a forward tilt of the human body or a backward tilt of the human body by comparing the determined left and right tilt posture value and the determined forward and backward tilt posture value with a left and right tilt posture threshold and a forward and backward tilt posture threshold, respectively, and
transmit a signal indicating at least one of the leftward tilt, the rightward tilt, the forward tilt, or the backward tilt of the human body determined by the first processor; and
a second processor configured to control a game play of a game in the vehicle based on the signal indicating at least one of the leftward tilt, the rightward tilt, the forward tilt, or the backward tilt of the human body determined by the first processor.

2. The game control system of claim 1, wherein the first processor is configured to:
acquire, prior to starting the game, an initial image including the human body through the camera,
determine whether the initial image includes one or more people,
based on a determination that the initial image includes one or more people, determine a game participant,
extract an image region of the game participant in the initial image, and
determine the left and right tilt posture threshold and the forward and backward tilt posture threshold corresponding to the posture of the human body in the initial image.

3. The game control system of claim 2, wherein the first processor is configured to:
determine an external parameter matrix between a camera coordinate system and a global coordinate system based on the initial image to which a human body detection algorithm is applied for determining the forward and backward tilt posture threshold corresponding to the posture of the human body in the initial image, and
apply a monocular depth estimation algorithm to the initial image to determine a human body depth in the camera coordinate system, and
convert, based on the determined external parameter matrix, the determined human body depth in the camera coordinate system to the human body depth in the global coordinate system, to determine the forward and backward tilt posture threshold corresponding to the posture of the human body in the initial image.

4. The game control system of claim 2, wherein the first processor is configured to:
acquire, through the camera, a real-time image including the human body during execution of the game for determining the leftward tilt or the rightward tilt, or the forward tilt or the backward tilt of the human body,
apply a human body detection algorithm to the real-time image to extract an image region of the game participant in the real-time image,
apply a skeletal key point detection algorithm to the extracted image region of the game participant to determine the left and right tilt posture value corresponding to the posture of the human body in the real-time image,
compare the left and right tilt posture value determined from the real-time image with the left and right tilt posture threshold determined from the initial image,
based on the left and right tilt posture value being greater than the left and right tilt posture threshold, determine that the human body is tilted to the left, and
based on the left and right tilt posture value being less than the left and right tilt posture threshold, determine that the human body is tilted to the right.

5. The game control system of claim 2, wherein the first processor is configured to:
apply a monocular depth estimation algorithm to the extracted image region of the game participant to determine the forward and backward tilt posture value corresponding to the posture of the human body in a real-time image,
compare the forward and backward tilt posture value determined from the real-time image with the forward and backward tilt posture threshold determined from the initial image,
based on the forward and backward tilt posture value being greater than the forward and backward tilt posture threshold, determine that the human body is tilted forward, and
based on the forward and backward tilt posture value being less than the forward and backward tilt posture threshold, determine that the human body is tilted backward.

6. A game control method based on a visual recognition algorithm, comprising:
acquiring, by a camera provided in an interior of a vehicle, an image including a human body;
receiving, by a first processor, the image from the camera;
determining, by the first processor, a left and right tilt posture value corresponding to a posture of the human body in the image acquired by the camera and a forward and backward tilt posture value corresponding to the posture of the human body in the image;
determining, by the first processor, a leftward tilt of the human body or a rightward tilt of the human body, or a forward tilt of the human body or a backward tilt of the human body by comparing the determined left and right tilt posture value and the determined forward and backward tilt posture value with a left and right tilt posture threshold and a forward and backward tilt posture threshold, respectively;
transmitting a signal indicating at least one of the leftward tilt, the rightward tilt, the forward tilt, or the backward tilt of the human body determined by the first processor; and
controlling, by a second processor, a game play of a game in the vehicle based on the signal indicating at least one of the leftward tilt, the rightward tilt, the forward tilt, or the backward tilt of the human body determined by the first processor.

7. The game control method of claim 6, further comprising:
acquiring, prior to starting the game, an initial image including the human body through the camera;
determining, by the first processor, whether the initial image includes one or more people;
based on a determination that the initial image includes one or more people, determining, by the first processor, a game participant;
extracting an image region of the game participant in the initial image; and
determining the left and right tilt posture threshold and the forward and backward tilt posture threshold corresponding to the posture of the human body in the initial image.

8. The game control method of claim 7, wherein the determining the left and right tilt posture threshold and the forward and backward tilt posture threshold corresponding to the posture of the human body in the initial image comprises:
determining, by the first processor, an external parameter matrix between a camera coordinate system and a global coordinate system based on the initial image to which a human body detection algorithm is applied;
applying, by the first processor, a monocular depth estimation algorithm to the initial image to determine a human body depth in the camera coordinate system; and
based on the determined external parameter matrix, converting, by the first processor, the determined human body depth in the camera coordinate system to the human body depth in the global coordinate system, to determine the forward and backward tilt posture threshold corresponding to the posture of the human body in the initial image.

9. The game control method of claim 7, wherein the determining the leftward tilt or the rightward tilt, or the forward tilt or the backward tilt of the human body comprises:
acquiring, through the camera, a real-time image including the human body during execution of the game;
applying, by the first processor, a human body detection algorithm to the real-time image to extract an image region of the game participant in the real-time image;
applying, by the first processor, a skeletal key point detection algorithm to the extracted image region of the game participant to determine the left and right tilt posture value corresponding to the posture of the human body in the real-time image;
comparing, by the first processor, the left and right tilt posture value determined from the real-time image with the left and right tilt posture threshold determined from the initial image; and
based on the left and right tilt posture value being greater than the left and right tilt posture threshold, determining, by the first processor, that the human body is tilted to the left.

10. The game control method of claim 7, wherein the determining the leftward tilt or the rightward tilt, or the forward tilt or the backward tilt of the human body comprises:
applying, by the first processor, a monocular depth estimation algorithm to the extracted image region of the game participant to determine the forward and backward tilt posture value corresponding to the posture of the human body in a real-time image;
comparing, by the first processor, the forward and backward tilt posture value determined from the real-time image with the forward and backward tilt posture threshold determined from the initial image; and
based on the forward and backward tilt posture value being greater than the forward and backward tilt posture threshold, determining, by the first processor, that the human body is tilted forward.

11. A method for providing a game, the method comprising:
communicating, via a communication interface of a vehicle, with a game device detected in the vehicle;
capturing, by one or more cameras of the vehicle, one or more first images depicting an interior of the vehicle;
receiving, by an image processor of the vehicle, the one or more first images from the one or more cameras;
processing, by the image processor, the one or more first images to identify one or more human bodies;
identifying, from the one or more human bodies, a participant of a game executed on the game device;
receiving, by the image processor from the one or more cameras, one or more second images depicting the participant of the game;
processing the one or more second images to determine a degree of tilt, by the participant of the game, in one or more directions;
transmitting, to the game device via the communication interface of the vehicle, a signal indicating the determined degree of tilt; and
causing the game device to control of an interactive portion of the game based on comparing the degree of tilt to a threshold.

12. The method of claim 11, wherein the processing the one or more second images to determine the degree of tilt comprises processing the one or more second images using a monocular depth estimation algorithm.

13. The method of claim 11, wherein the processing the one or more second images to determine the degree of tilt comprises processing the one or more second images using a skeletal key point detection algorithm.

14. The method of claim 11, wherein the threshold is based on a location of the participant of the game in the one or more first images.

15. The method of claim 11, wherein the processing the one or more first images comprises using a human body detection algorithm to identify the one or more human bodies.

16. The method of claim 11, wherein the processing the one or more second images to determine the degree of tilt comprises:
determining a camera coordinate system corresponding to the one or more cameras;
determining a global coordinate system; and
comparing the camera coordinate system and the global coordinate system.

17. The method of claim 11, wherein the communicating, via the communication interface of the vehicle, with the game device comprises:
receiving, from the game device via the communication interface, a wireless signal indicating a request for detecting the participant of the game and for determining the degree of tilt.

18. The method of claim 11, wherein the one or more cameras are located on a front windshield glass of the vehicle.

19. The method of claim 11, wherein the identifying the participant of the game is based on determining that the participant is in a front seat of the vehicle.
